(19) United States
(12) Patent Application Publication
(10) Pub. No.: US 2004/0202770 A1
(43) Pub. Date: Oct. 14, 2004

(54) Micronised fat particles

(76) Inventors: Frederick William Cain, Wormerveer (NL); Anthony George Herzing, Channahon, IL (US); Gerald Patrick McNeill, Channahon, IL (US)

Correspondence Address: MORGAN LEWIS & BOCKIUS LLP, 1111 PENNSYLVANIA AVENUE NW, WASHINGTON, DC, 20004, US

(21) Appl. No.: 10/480,141

(22) PCT Filed: May 30, 2002
(86) PCT No.: PCT/EP02/05983

(30) Foreign Application Priority Data
Jun. 13, 2001 (US) 09/879,863

(51) Int. Cl. A23D 7/00

(52) U.S. Cl. 426/601

(57) ABSTRACT

The invention concerns with micronised fat continuous particles comprising fat and non fat ingredients, wherein particles have a mean weight diameter (MWD) of 700 to 4000 microns, while the particles have a particle size distribution so more than 75 wt % of the particles have a particle size that is inside the range (MWD+0.4×MWD) to (MWD−0.4×MWD); products comprising a fat phase, wherein these particles are present, a process to prepare these micronised fat particles and the of these particles in food products to achieve benefits, such as bioavailability, stability, oral melt, hardness, texture, homogeneity ease of dosing.

Micronised fat continuous particles, comprising fat and non-fat ingredients are well known in the art and are even applied on a commercial scale. The micronised fat particles known so far however have. a broad particle size distribution. We found that such particles had a number of drawbacks when applied in food products such as baked bakery products (the baking process is negatively affected by the presence of fines in the particles, while the presence of too high amounts of the bigger particles can have a negative impact on the performance of the yeast required in many bakery products). Further are the colour and flavour of ice creams negatively affected by the presence of fines in the particles whereas in confectionery products like truffle fillings and toffees the presence of too much of the bigger particles deteriorate the taste performance of the products.

We studied whether we could overcome the problems indicated above and we found as a result hereof that the use of particles with a specific particle size distribution could solve these problems. Therefore our invention concerns in the first instance micronised fat continuous particles comprising fat and non fat ingredients, wherein the particles have a mean weight diameter (MWD) of 700 to 4000 microns, while the particles have a particle size distribution so that more than 75 wt % of the particles have a particle size that is inside the range (MWD+0.4×MWD) to (MWD−0.4×MWD).

The MWD is defined as set out in the examples wherein also the method to measure the MWD is given.

Preferably particles are applied wherein MWD is 1000 to 3500 microns, most preferably 1500 to 3000 microns. The best results were obtained when using particles having a size distribution so that more than 75 wt % is inside the range (MDW+0.3×MDW) to (MDW−0.3×MDW).

The micronised particles contain fat ingredients and non-fat ingredients preferably in such amounts that the particles comprise 10 to 90 wt % of non fat ingredients, preferably 20 to 80 wt %, more preferably 25 to 60 wt %. These non-fat ingredients are preferably selected from the group consisting of sugars, carbohydrates, starches, modified starches and flavouring compounds and thus are preferably nutritionally active ingredients.

Although a wide range of fats can be applied we found that the best results were obtained if the fats display a melting point between −5° C. and 75° C., preferably between 10 and 50° C., most preferably between 15 and 45° C. Preferred fats meeting these requirements can be selected from the group consisting of: sunflower oil, palm oil, rape oil, cotton seed oil, soy bean oil, maize oil, shea oil, cocoa butter or fractions thereof or in a hardened form or as fraction of the hardened oil or as partially hydrolysed oil rich in diglycerides or as mixtures thereof. Very beneficial is also the use of nutritionally active fats, preferably selected from a CLA-glyceride or a fat that comprises PUFA fatty acid in high amounts such as fish oil, fish oil concentrates, fungal oils, as the use of these fats will add the nutritional benefits of these fats to the micronised particles and thus to the end product.

Flavours that can be applied are in principle all known flavours but we prefer to apply flavours selected from the group consisting of butter flavour, cinnamon flavour, fruit flavour, cheese flavour.

Very suitable micronised particles are obtained by producing particles with a water content of less than 2 wt %.

The micronised particles are very effective for use in food products as alternative for the known fat flakes, known as BetrFlakes ^{R} which are commercially on the market (product from Loders Croklaan).

The micronised particles can be used for the preparation of food products with a fat phase wherein more than 30 wt % of the micronised particles is present. Typical food products are food products selected from the group consisting of ice cream, baked goods, coatings, fillings, toppings, soups, sauces, dry mixes, spreads.

The micronised particles according to the invention can be made by a process comprising the following steps:

a fat melt is made

non fat ingredients are slurried in the molten fat

the slurry is cooled, preferably on a flaking drum cooler

flakes of a fat continuous slurry are collected from the drum flaker

which flakes optionally are reduced in size, preferably by a breaker bar system

whereupon either the flakes or the size reduced flakes are subjected to a cryo-milling by cooling them with a cryo-coolant, such as liquid nitrogen or solid carbon dioxide and reducing them in size while cold, in particular while having a temperature of −20 to 10° C.

In above process we prefer to perform a milling in a cryo-miller to a particle size of more than 20 microns and in particular to particles with a size as required for the products according to the invention.

The flakes can also be obtained by using other cooling equipment, such as a cooling belt. The fat melt can be subjected to an initial cooling using equipment such as a Sandvik Belt® or a confectionery cooling tunnel.

According to a last embodiment of our invention the invention concerns also the use of the micronised particles according to the invention to achieve a number of benefits in food products i.e.:

improve the bioavailability of the nutritional ingredients present in the particles and/or

to improve the stability of the nutritional ingredients present in the food products and/or

to improve oral melt, hardness or texture of food products and/or

to improve the homogeneity of the active ingredient in the food products and/or

to improve the ease of dosing of minor components in food products.

Other beneficial applications of our micronised particles are:

the use as inclusions in fat systems applied in the preparation of laminated dough systems

the use for the preparation of bake stable bakery toppings

the use in frying systems as fry stable inclusions

use as inclusions in margarines specifically margarines for bakery applications such as cakes and muffins

use in bakery products that will be subjected to reheating by microwaves

use in fat systems or cheese based systems that are shakeable.

### EXPERIMENTAL PART

Processing

1.1 Method

Process Flakes—Standard Procedure.

The ingredients used for the flake procedure were:

Icing sugar

Fat blend

Sanding sugar

Unbleached pastry flour

Powdered Lecithin

Colour and flavour system, depending on the type

1. The process began by producing slurry of fat and powders and/or liquid or dry flavours. This was mixed in a vacuum rated vessel.

2. After mixing the slurry was pumped to a flake roll which was cooled to a temperature between −18 and 38° C., depending on the melting point of the fat

3. The fat and dry particulate slurry was applied to the outside of the roll and was cooled to the point of solidification and scraped off using a knife blade.

4. The chilled slurry, now in the form of large flakes or sheets felt into a hopper where it was broken into conveyable sized pieces by a breaker bar system.

5. Flakes were ready to subject to a cryo-milling process, like described next.

Process Fractions—Standard Procedure.

The starting material was either standard BetrFlakes (10×10×4 millimetres) or mini BetrFlakes (10×4×3 millimetres). The flakes were cooled to less than 0° C. by adding solid carbon dioxide. The Quadro Comil model no. 197GPS® was set on a speed setting using a specific grater screen. The flakes were added into the Quadro Comil by hand and the ground material (unsieved material) was collected. The ground unsieved material was separated into three fractions using a Sweco Separator (Vibro Energy® 1200 rpm) model no. 1S30S444. Three fractions were collected:

fraction A, those retained on a US#8 (2360 microns)

fraction B, those who went through a US#8 (2360 microns) and retained on a US#16 (1180 microns)

fraction C, those who went through a US#16 (500 microns)

The weight of each fraction was measured and expressed as the weight percent of the total material used.

In each fraction as well as in the unsieved material the particle size distribution was determined using a Ro-Tap Testing Sieve Shaker® model no. B. A known weight of the sample was shaken for 5 minutes in the Ro-Tap. The weight of material retained by each sieve was measured and expressed as a weight percent of the total material used. The screen sizes, used in a Ro-Tap Testing Sieve Shaker® (model no. B), are described in table 1.1.

TABLE 1.1
The US screens of the Ro-Tap Testing Sieve Shaker in microns

| Screen size | | Average Diameter |
|---|---|---|
| (mesh) | Diameter microns) | (microns) |
| On US#4 | 4750 microns | 4750 |
| On US#6 | 3350 microns | 4050 |
| On US#8 | 2360 microns | 2855 |
| On US#10 | 2000 microns | 2180 |
| On US#12 | 1700 microns | 1850 |
| On US#14 | 1400 microns | 1550 |
| On US#16 | 1180 microns | 1290 |
| On US#18 | 1000 microns | 1090 |
| On US#20 | 850 microns | 925 |
| Through US#20 | 500 microns | 675 |
| On US#30 | 600 microns | 725 |
| On US#40 | 425 microns | 512.5 |
| On US#50 | 300 microns | 362.5 |
| Through US#50 | 250 microns | 275 |

For each fraction the mean weight diameter in microns was determined.

The average diameter of the material passing screen size “y” and retained by screen size “x” equals:

$$\frac{( Diameter of screen x ) + ( Diameter of screen y )}{2}$$

Whereas “y”=the next widest screen size than “x” which was used in the Ro-Tap.

The average diameters of the screens used in the Ro-Tap during the experiment are described in table 1.1.

The particle size distribution was determined as:

Weight percentage of material with each of these average diameters

The mean weight diameter was calculated using the following formula:

1. For each diameter in a fraction weight diameter was calculated:

Average diameter×Weight fraction of that average diameter

2. Mean weight diameter:

All weight diameters of the fraction summed

To clarify this a calculation will be given for the data from table 1.2.

| | |
|---|---|
| 4050 × 0.072 = | 291.6 |
| 2855 × 0.7 = | 1998.5 |
| 2180 × 0.213 = | 464.3 |
| 1850 × 0.01 = | 18.5 |
| 1550 × 0.002 = | 3.1 |
| | = 2776 microns |
| | (Mean weight diameter) |

TABLE 1.2
Particle size distribution of example fraction x

| Diameter | Average Diameter | | |
|---|---|---|---|
| (microns) | (microns) | Fraction | Cumulative % |
| 4750 | | 0 | 0 |
| 3350 | 4050 | 0.072 | 7.2 |
| 2360 | 2855 | 0.7 | 77.2 |
| 2000 | 2180 | 0.213 | 98.5 |
| 1700 | 1850 | 0.01 | 99.5 |
| 1400 | 1550 | 0.002 | 99.7 |

Table 1.2 Particle Size Distribution of Example Fraction x

The percentage of particles within the range (MWD−MWD*0.4)−(MWD+MWD*0.4) was calculated using the following formula (as an example of calculation data in table 1.2 are used):

1. Determination of the range

(MWD−MWD×0.4) to (MWD+MWD×0.4)

from table 1.2: (2776−2776*0.4) to (2776+2776*0.4)

Range=1666 to 3886 microns

2. Calculation of percentage of particles in specified range The percentage in range is the difference between the cumulative % at (MWD−MWD*0.4) and (MWD+MWD*0.4).

Cumulative % at (MWD+MWD*0.4):

$$\frac{( A - X1 ) \times P B + ( X1 - B ) \times P A}{A - B}$$

from table 1.2:

(4750−3886)×0.0+(3886−3350)×0.0)/(4750−3350)=0.0%

Cumulative % at (MWD−MWD*0.4)

$$\frac{( C - X2 ) \times P D + ( X2 - D ) \times P C}{C - D}$$

from table 1.2:

(1700−1666)×99.7+(1666−1400)×99.5)/(1700−1400)=99.5%

Percentage of particles in range=99.5−0.0=99.5%

Legend:

| | | Value from |
|---|---|---|
| Code | Description | table 1.2 |
| A | 1^{st} datapoint above (MWD + MWD*0.4) | 4750 microns |
| X1 | (MWD + MWD*0.4) | 3886 microns |
| B | 1^{st} datapoint below (MWD + MWD*0.4) | 3350 microns |
| PA | Cumulative % of A | 0.0% |
| PB | Cumulative % of B | 0.0% |
| C | 1^{st} datapoint above (MWD − MWD*0.4) | 1700 microns |
| X2 | (MWD − MWD*0.4) | 1666 microns |
| D | 1^{st} datapoint below (MWD − MWD*0.4) | 1400 microns |
| PC | Cumulative % of C | 99.5% |
| PD | Cumulative % of D | 99.7% |

1.2 Determination of Particle Size Distribution and Mean Weight Diameter

In this paragraph the particle size distribution and the mean weight diameter will be described for different products. In the different patent examples a reference will be made to these data.

### Experiment 1

Following standard procedure as described in Method 1.1.

Used products and settings;

| | |
|---|---|
| Flakes: | Mini Raspberry BetrFlakes |
| Speed Comil: | 17650 rpm |
| Screen size Comil: | 156G |

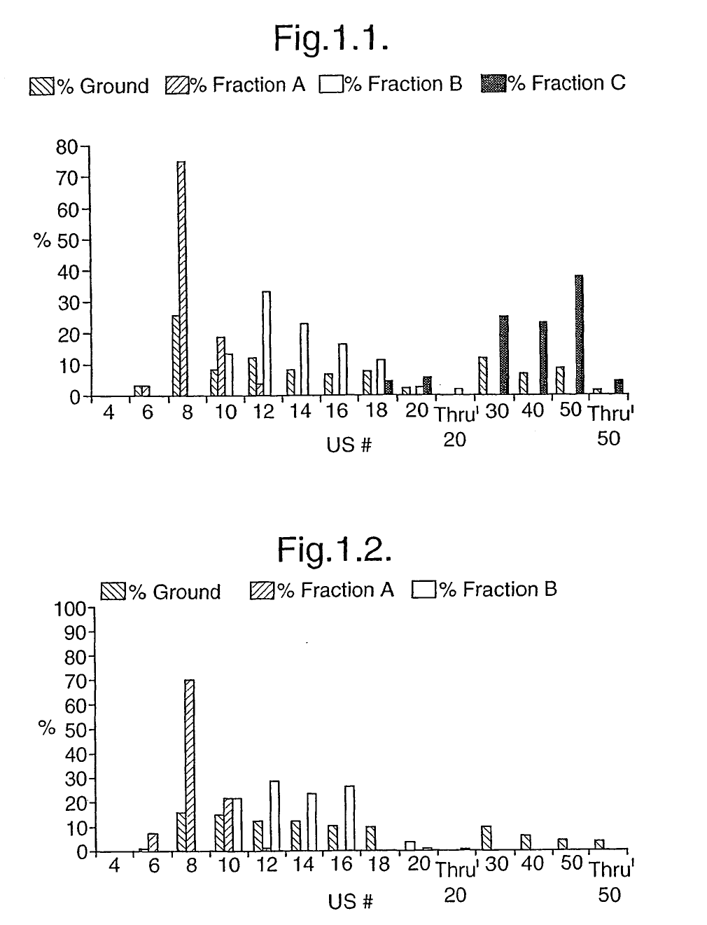

The weight percentage of fractions recovered from the ground material is described in table 1.3. The particle size distribution of the ground material and the particle size distribution of each fraction can be found in FIG. 1.1 and in the appendix tables 1.10 until 1.14.

TABLE 1.3
The weight percentage of fractions recovered from
ground material from experiment 1 (cf FIG. 1.1)

| Fraction recovered | Weight |
|---|---|
| from ground material | Percentage (%) |
| Fraction A | 31.55 |
| Fraction B | 36.71 |
| Fraction C | 31.75 |

Table 1.3 The Weight Percentage of Fractions Recovered from Ground Material from Experiment 1 (cf FIG. 1.1)

### Experiment 2

Following Laboratory Flake make-up Procedure and Ice Cream Fraction Comil Procedure, like described below;

Used products and settings;

| | |
|---|---|
| Flakes: | Raspberry Paramount B flakes |
| Speed Comil: | 0 rpm |
| Screen size Comil: | 156G |

Laboratory Flake Make-Up Procedure

The recipe for these flakes is given in table 1.4.

1. Dry ingredients (icing sugar 6×, sanding sugar, 28 DE maltodextrin, malic acid, tricalcium phosphate, sodium citrate dihydrate, raspberry powder, red lake, blue lake, and lecithin) were combined in a small Hobart (model no. C-100) bowl. Water jacket was set at 41-43° C.

2. Mixed for approximately ten minutes on (speed 1).

3. The Paramount B was melted and added to the dry ingredients in Hobart. Mixed for approximately fifteen minutes on (speed 1) maintaining water jacket temperature of 41-43° C.

4. Artificial raspberry flavour was added to mixture and mixed for five minutes.

5. The molten mass was spread on a pre-chilled baking sheet with parchment liner.

6. Returned sheet to freezer (−22° C.) for approximately twenty minutes.

7. Removed sheet and allowed standing at room temperature for fifteen minutes.

8. Cut into small rectangular pieces.

Ice Cream Fraction Comil Procedure

1. The Quadro Comil (model no. 197GPS) was set at zero speed with 0.156 size greater.

2. One thousand-gram batch of small rectangular pieces was milled through mill and the material was collected.

3. Five hundred grams of unsieved material was taken and a particle size distribution on a Ro-Tap Testing Sieve Shaker model no. B was run. The other five hundred grams was hand sieved on size # 8 and # 16 screens. Subsequent particle size distribution was performed on these two sizes on a Ro-Tap Testing Sieve Shaker model no. B.

TABLE 1.4
Recipe Paramount B Raspberry Flakes for ice cream application

| Ingredients | % |
|---|---|
| Paramount B | 30 |
| Icing Sugar 6X | 30.13 |
| Sanding sugar | 16 |
| 28 DE Maltodextrin 178176 | 17 |
| Malic Acid | 1.5 |
| Tricalcium Phosphate | 0.4 |
| Sodium citrate, dihydrate | 0.3 |
| Rasp Art. F95133 Mane | 1.5 |
| DD-40 Raspberry PDR VD | 3 |
| FD&C RED # 40 09310 | 0.1 |
| FD&C Blue # 2 09901 | 0.01 |
| Lecithin, liquid | 0.06 |

The weight percentage of fractions recovered from the ground material is described in table 1.5. The particle size distribution of the ground material and the particle size distribution of each fraction can be found in FIG. 1.2 and in the appendix tables 1.15 until 1.18.

TABLE 1.5
The weight percentage of fractions recovered
from ground material from experiment 2

| Fraction recovered from | |
|---|---|
| ground material | Weight Percentage (%) |
| Fraction A | 34.6 |
| Fraction B | 40.5 |
| Fraction C | 12.3 |

### Experiment 3

3.1 Bread Application

3.1.1 Ingredients

The used ingredients in this experiment-were:

Bread Flour

Granulated Sugar

Salt

Non Fat Dry Milk Powder

Betrkake Shortening

Dry Yeast, Red Star Active Dry

Water

Raspberry fraction A from experiment 1 (on US #8, PSD>than 2,360 microns)

Raspberry fraction B from experiment 1 (on US #16, PSD less than 2,360 microns and greater than 1,180 microns

Raspberry ground, unsieved material from experiment 1 (Particle size distribution from 4,750 microns to 500 microns)

3.1.2 Method

Standard white bread dough was prepared using the following formula:

TABLE 1.6
Recipe Bread Dough application

| Ingredients | Percentage (%) |
|---|---|
| Bread Flour | 54.0 |
| Granulated Sugar | 1.8 |
| Salt | 0.8 |
| Non Fat Dry Milk Powder | 1.8 |
| Betrkake Shortening | 1.8 |
| Dry Yeast, Red Star Active Dry | 0.8 |
| Water at 43o C. | 39.0 |
| Total | 100% |

The Bread dough was prepared using a standard dough making procedure.

Procedure:

1. Flour, Granulated Sugar, Salt and Non-Fat Dry Milk and dry yeast were scaled into mixing Bowl and mixed until homogeneous first speed Hobart mixer with Dough hook).

2. Betrkake Shortening was added and gradually water was added until dough was formed.

3. Mixed on medium speed (speed #2) for 3-speed mixer for 10 to 12 minutes until gluten was fully developed.

4. Following preparation of the Bread dough a measured portion of the dough was taken. To that portion the following material were added to each portion:

5.

Portion 1

Added 10% by weight Raspberry fraction A from experiment 1 to Bread dough prepared as above. Fraction was incorporated by mixing Hobart mixer with dough hook, 5 minutes.

Portion 2

Added 10% by weight Raspberry fraction B from experiment 1 to Bread dough prepared as above. Fraction B was incorporated by mixing Hobart mixer with dough hook, 5 minutes.

Portion 3

Added 10% by weight ground, unsieved Raspberry material from experiment 1. The non-fractionated material was incorporated by mixing Hobart mixer with dough hook, 5 minutes.

6. Proofing and baking

Following incorporation of the Fractions the doughs prepared from portion 1, 2 and 3 were placed in a bowl and proofed for 1 hour. Dough was punched down, molded into loaves and proofed for another 20-30 minutes. Loaves were removed and baked at 204° C. for 25-30 minutes.

7. Baked loafs were cooled, weighed and measured for volume.

3.1.3 Evaluation Method Bread Scoring

The bread volume was measured by Rapeseed displacement method. A loaf was placed in a container of known volume into which small seeds e.g. rapeseed were run until the container was full. The volume of the seeds displaced by the loaf was measured. Loaf volume per weight was then calculated.

3.1.4 Results and Conclusion

Raspberry Bread loaf Portion 3 using non-fractionated material the bread volume when measured was found to be 19.45% less than the bread prepared with fractionated material Portion 1.

Raspberry Bread loaf Portion 2 using non-fractionated material the bread volume when measured was found to be 9.1% less than the bread prepared with fractionated material Portion 1.

From this data it can be concluded that using Raspberry fractions resulted in a larger bread volume than using ground, unsieved material. Within the bakery market it is well recognised that bread with a larger bread volume results in a more desirable texture than obtained with low bread volume. Using the unsieved Raspberry material the common baking procedure led to a poor bread volume, however using fraction A or fraction B of the Raspberry material larger, desirable bread volumes were obtained.

### Experiment 4

Part 4.1 Ice Cream Application

4.1.1 Ingredients

The ingredients used in this experiment were:

Artificially flavoured vanilla ice cream (Nancy Martin)

Raspberry; fraction A from experiment 2 (on US #8, PSD>than 2,360 microns)

Raspberry; ground, unsieved material from experiment 2 (Particle size distribution from 4,750 microns to 500 microns)

4.1.2 Method

Procedure:

1. 10% by weight ground, unsieved Raspberry material from experiment 2 were put in artificially flavoured vanilla ice cream. As well 10% by weight Raspberry fraction A from experiment 2 were put in artificially flavoured vanilla ice cream.

2. The samples were put in cups and were coded R for the unsieved ground ice cream application and F for the ice cream application with fraction A.

3. A sensory panel evaluated the samples. A panel was run to determine significant differences in the areas of:

Visual identity between ice cream and inclusion

Textural differences

Flavour burst and balances between ice cream and inclusion

4.1.3 Sensory Evaluation Method

Each evaluation was carried out by the same sensory panel, which consists of 12 persons. The evaluation panels were conducted under the same conditions and the same procedures. The panellists evaluated the products against each other with one of them as a reference for different described attributes. The sensory score sheet included a line scale for each attribute. The range from the scale went from −3 until +3, wherein the reference is zero on the line scale.

+/−3.0=big difference

+/−2.5=very clear difference

+/−2.0=clear difference

+/−1.5=very noticeable difference

+/−1.0=noticeable difference

+/−0.5=slight difference

0=same as reference

The following attributes were evaluated by the sensory panel for the ice cream application:

| | Negative | 0 | Positive |
|---|---|---|---|
| Appearance of particles | fewer | 0 | more |
| Bleeding of the inclusions | less | 0 | more |
| Meltdown | slower | 0 | quicker |
| Waxiness | less | 0 | more |
| Chewiness | less | 0 | more |
| Flavour release time | slower | 0 | quicker |
| Flavour retention | shorter | 0 | longer |
| Flavour impact | less | 0 | more |
| Aftertaste | shorter | 0 | longer |
| Sourness | less | 0 | more |

4.1.4 Results and Conclusions

In table 1.7 the results of the sensory evaluation for the ice cream application can be found. Only the results for sample F (fraction A) are described, since sample R was the reference and was zero on the line scale. The data only shows the attribute results from the differences between the two samples. The other data is left out.

TABLE 1.7
Results of the sensory evaluation of ice cream application with
fraction A (sample F) regarding to the reference (sample R)

| | | | Number of | Number of |
|---|---|---|---|---|
| | | | panellists with | panellists with |
| Ice cream | Result of | Average of | positive or | specific |
| attribute | panel | the panel | negative | difference |
| Bleeding | less | −1.5 | 10/12 = less | 7/12 = −1.5, |
| of | | | bleeding of the | very noticeable |
| inclusions | | | inclusion | difference |
| Meltdown | slower | −1.2 | 9/12 = slower | 7/12 = −1.5, |
| | | | meltdown | very noticeable |
| | | | | difference |
| Waxiness | more | 0.9 | 7/12 = more | 7/12 = +2.0, |
| | | | waxy | clear difference |
| Chewiness | more | 1.1 | 10/12 = more | 6/12 = +2.0, |
| | | | chewy | clear difference |
| Flavor | slower | −0.8 | 10/12 = slower | 4/12 = −1.5, |
| release | | | flavour release | very noticeable |
| time | | | time | difference |

Table 1.7 shows that using fraction A resulted in a visual sensation of the inclusion, namely less bleeding compared to the unsieved Raspberry material. Using fraction A resulted as well in a more waxy and chewier inclusion sensation. A very noticeable difference in flavour release of the inclusion can be found when using Raspberry fraction A.

It can be concluded from these results, that the ice cream keeps looking like a white ice cream and the inclusions were distinctive from the ice cream, when using fraction A, since there was less bleeding. The ground unsieved material had more bleeding and therefore showed less visual identity between the white ice cream and the pink inclusion.

Secondly it can be concluded that using fraction A, there was a more oral sensation of the inclusions. The inclusions appeared to be more waxy and more chewy, so textural more identifiable as a distinctive inclusion. The unsieved material gave a less textural sensation; therefore it was more difficult to identify the inclusion being a distinctive inclusion.

Finally it appeared that there is clear flavour identification from both the ice cream and the inclusion when using fraction A of the Raspberry material. It showed namely a delayed flavour release from the inclusion. Using the unsieved Raspberry material as the inclusion, there was no distinctive flavour between substrate and inclusion, since there was less flavour release delay, so both flavours appeared at the same time.

Overall it can be concluded that using fraction A of the Raspberry material in an ice cream application has given an identifiable white ice cream with distinctive inclusions both visual and oral, where the unsieved Raspberry material did not.

### Experiment 5

Truffle

5.1.1 Ingredients

The following ingredients were used in this experiment:

Heavy whipping cream

42DE Corn syrup

Finely chopped white chocolate (Nestle)

Raspberry fraction B from experiment 1 (on US #16, PSD less than 2,360 microns and greater than 1,180 microns

Raspberry ground, unsieved material from experiment 1 (Particle size distribution from 4,750 microns to 500 microns)

5.1.2 Method

Standard white truffle filling was prepared using the formula like described in table 1.8.

TABLE 1.8
Recipe of truffle application

| Ingredient | Percentage (%) |
|---|---|
| Cream | 31 |
| 42 DE corn syrup | 4 |
| White chocolate | 50 |
| Raspberry fraction | 15 |
| Total | 100 |

The standard white truffle filling was prepared using a standard white truffle filling making procedure.

Procedure:

1. Weighed the cream and the corn syrup directly into a pan.

2. Weighed out the chocolate in a bowl and then chopped into fine pieces using a cutting board.

3. The raspberry fraction was weighed into a large stainless steel bowl.

4. The cream and the corn syrup were boiled.

5. Poured the cream into the chocolate. The mixture was gently stirred until chocolate was melted.

6. Fraction B Raspberry from experiment 1 was added to the chocolate mixture. Sit was stirred gently.

7. Sample cups were filled and coded F.

The same procedure and formula were used for the 2^{nd} run, however using Raspberry ground unsieved material from experiment 1. These samples were coded R for the sensory panel.

A sensory panel evaluated the samples. A panel was run to determine significant differences in the areas of:

Visual identity between white truffle filling and inclusion

Textural differences

Flavour burst and balances between truffle filling and inclusion

5.1.3 Sensory Evaluation Method

Each evaluation was carried out by the same Sensory panel, which consists of 12 persons. The evaluation panels were conducted under the same conditions and the same procedures.

The panelists evaluated the products against each other with one of them as a reference for different described attributes.

The sensory score sheet included a line scale for each attribute. The range from the scale went from

−3 until +3, wherein the reference is zero on the line scale.

+/−3.0=big difference

+/−2.5=very clear difference

+/−2.0=clear difference

+/−1.5=very noticeable difference

+/−1.0=noticeable difference

+/−0.5=slight difference

0=same as reference

The following attributes were evaluated by the sensory panel for the truffle application:

| | Negative | 0 | Positive |
|---|---|---|---|
| Appearance of | fewer | 0 | more |
| particles | | | |
| Bleeding of | less | 0 | more |
| the inclusions | | | |
| Meltdown | slower | 0 | quicker |
| Waxiness | less | 0 | more |
| Chewiness | less | 0 | more |
| Flavour release time | slower | 0 | quicker |
| Flavour retention | shorter | 0 | longer |
| Flavour impact | less | 0 | more |
| Aftertaste | shorter | 0 | longer |
| Sourness | less | 0 | more |

5.1.4 Results and Conclusions

In table 1.9 the results of the sensory evaluation for the truffle application can be found. Only the results for sample F (fraction A) are described, since sample R is the reference and was zero on the line scale. Table 1.9 shows only the attribute results, which appeared to be different between the two evaluated samples. All the other data was left out.

TABLE 1.9
Results of the sensory evaluation of white truffle filling with
fraction B (sample F) regarding to the reference (sample R)

| | | | Number of | Number of |
|---|---|---|---|---|
| | Result | Average | panellists | panellists |
| Truffle | of | of the | positive or | specific |
| attribute | panel | panel | negative | difference |
| Bleeding | less | −2.2 | 12/12 = less | 9/12 = −2.0, |
| of | | | bleeding of the | clear |
| inclusions | | | inclusion | difference |

It showed that using Raspberry fraction B resulted in a visual sensation of the distinctive inclusion pieces, namely less bleeding compared to the unsieved Raspberry material.

It can be concluded from this data that with the unsieved Raspberry material it was less possible to identify a pink inclusion in a white truffle filling, since there was more bleeding of the inclusion into the substrate. The white truffle filling was not identifiable anymore as being a white truffle filling. Using Raspberry from fraction A, it showed less bleeding and therefore a more identifiable substrate with a distinctive inclusion.

### Experiment 6

Improved bioavailability of micronised fat particles compared to large fat particles

6.1. Material and Methods

Production of β-Carotene Micronised Fat Particles

The following ingredients were used in this experiment:

| Ingredient | Percentage |
|---|---|
| Aratex L (partially hydrogenated vegetable | 36.00% |
| oil - soybean and cotton seed) | |
| Unbleached pastry flower | 34.50% |
| Maltodextrin | 24.40% |
| NaCl | 1.97% |
| Citric acid, granulate | 0.49% |
| □-carotene, 30% in oil (Roche) | 2.64% |

Micronised fat particles were produced following laboratory flake make-up procedure, as reported in the patent (Method 1.1). A 156G screen size Comil was used at 1800 rpm for grinding.

Small β-carotene micronised fat particles were sieved and the fraction between US #16 and #8 (RoTap sieves) obtained.

Large fat particles were obtained following the same procedure used to produce micronised fat particles except that they were big enough to be retained by sieve #3.5 (5600 micron). A 312G screen size Comil at 1200 rpm was used for grinding.

Bioavailability Experiment

The bioavailability experiment was carried out following the procedure reported on Lipids, 33, 10, 985-992 (1998).

Transfer of β-carotene from micronised fat particles to olive oil was measured in 100 ml, stoppered glass flasks (Beatson Clarkglass). The area of undisturbed oil/water interface was 16 cm². The aqueous phase (30 ml) contained 2.5 g of micronised fat particles (or large fat particles) and 70 mM NaCl. The solution was adjusted to pH 2 with HCl and pre-equilibrated at 37° C. in an Orbital Incubator SI 50 (Stuart Scientific) prior the addition of the micronised fat particles (or large fat particles).

The oil was then added (12 ml) and the flasks returned to the incubator, set up for shaking at speed 80. Samples of the oil phase (100 μl) were taken after 1 h incubation, since it has been reported that that is the residence time of the meal in the stomach (J. Agric. Food Chem., 47, 4301-4309, 1999). β-Carotene was measured by diluting such aliquots of oil into 2 ml n-hexane and measuring the absorbance at 450 nm using a mM extinction coefficient of 137.4.

Each sample was run in triplicate.

6.2. Results

Production of β-Carotene Micronised Fat Particles

The percentage of sieved (retained between sieves #8 and #16) micronised fat particles within ±0.4*MWD was 98.2%. The percentage was calculated as reported in the patent (Method 1.1).

The particle size distribution of the micronised fat particles retained between sieve #8 and #16 was the following.

| | Screen | Mean | | |
|---|---|---|---|---|
| us# | size | Size | Grams | % |
| 8 | 2360 | 2855 | 0.17 | 0.17% |
| 10 | 2000 | 2180 | 25.57 | 25.61% |
| 12 | 1700 | 1850 | 30.76 | 30.81% |
| 14 | 1400 | 1550 | 26.22 | 26.26% |
| 16 | 1180 | 1290 | 12.73 | 12.75% |
| 18 | 1000 | 1090 | 3.8 | 3.81% |
| 20 | 850 | 925 | 0.13 | 0.13% |
| Pan | 500 | 675 | 0.46 | 0.46% |
| Total | | | 99.84 | 100.00% |

[image]

The MWD of the micronised fat particles was 1750.5.

Bioavailability Experiment

The average concentration of β-carotene in the oil phase after incubation with large fat particles or micronised fat particles was 0.9 nM and 1.4 nM respectively.

6.3. Conclusions

The micronised fat particles produced were within the patent specification for what concerns the MWD and the particle size distribution.

Compared to large fat particles, of bigger size, micronised fat particles showed improved bioavailability of the functional ingredient β-carotene.

### Experiment 7

Improved homogeneity of micronised fat particles compared to large fat particles in a food product (bread).

7.1. Material and Methods

Production of β-Carotene Micronised Fat Particles

The following ingredients were used in this experiment:

| Ingredient | Percentage |
|---|---|
| Aratex L (partially hydrogenated vegetable | 36.90% |
| oil - soybean, cottonseed) | |
| Unbleached pastry flower | 35.40% |
| Maltodextrin | 24.9% |
| NaCl | 2% |
| Citric acid, granulate | 0.5% |
| β-carotene, 30% in oil (Roche) | 0.3% |

Micronised fat particles were produced following laboratory flake make-up procedure, as reported in the patent (Method 1.1). A 156G screen size Comil was used at 1800 rpm.

Small β-carotene micronised fat particles were sieved and the fraction between US #16 and #8 (RoTap sieves) obtained.

Large fat particles were obtained following the same procedure used to produce micronised fat particles except that they were big enough to be retained by sieve #3.5 (5600 micron). A 312G screen size Comil at 1200 rpm was used for grinding.

Bread Production

About 430 g of bread was made containing micronised fat particles or large fat particles. Bread was produced with the following ingredients:

| Ingredient | Percentage |
|---|---|
| Flour | 58.2% |
| Yeast | 1.16% |
| Salt | 1.16% |
| Margarine | 0.58% |
| Sugar | 1.16% |
| Water | 30.4% |
| Micronised or large fat particles | 7.34% |

The yeast was dissolved in part of the water. All other ingredients were mixed together to form a dough. After fermentation for 40 min and rework, carried out three times in total, the bread was baked at 250° C. for 35 min.

Extraction of β-Carotene from Bread

A slice of bread (without the crust) of about 1.5 cm thickness was cut in 4 squares of 7.5 g each. Each 7.5 g quarter of bread was extracted with iso-octane/water (2:1). Exactly 200 ml of iso-octane were added to the bread in a 300 ml beaker, followed by the addition of 100 ml of deionised water.

The sample was then homogenised in an Ultraturrax T25, Janke & Kunkel. Settings were 8000 min⁻¹ for 15 sec followed by 2 min at 9500 min⁻¹.

Afterwards the sample was immediately transferred into a 300 ml conical flask with lid and left for separation for 30 min in the dark.

After 30 min the iso-octane layer containing β-carotene clearly separated from the water layer.

The absorbance of the iso-octane layer was read with a UV-VIS spectrophotometer set up at 450 nm. The E^{nM} of β-carotene was 137.4, as reported on Lipids, 33, 10, 985-992 (1998).

7.2 Results

Production of β-Carotene Micronised Fat Particles

The percentage of sieved (retained between sieves #8 and #16) micronised fat particles within ±0.4*MWD was 98.4%. The percentage was calculated as reported in the patent (Method 1.1).

The particle size distribution of the micronised fat particles was the following:

Retained between sieve #8 and #16

| | Screen | Mean | | |
|---|---|---|---|---|
| us# | size | size | Grams | % |
| 8 | 2360 | 2855 | 0.18 | 0.18 |
| 10 | 2000 | 2180 | 21.73 | 21.55 |
| 12 | 1700 | 1850 | 28.8 | 28.56 |
| 14 | 1400 | 1550 | 27.07 | 26.84 |
| 16 | 1180 | 1290 | 15.75 | 15.62 |
| 18 | 1000 | 1090 | 6.49 | 6.44 |
| 20 | 850 | 925 | 0.39 | 0.39 |
| Pan | 500 | 675 | 0.43 | 0.43 |
| Total | | | 100.84 | 100 |

The particle size distribution is also shown in the following graph.

[image]

The MWD was of the micronised fat particles was 1697.4.

Extraction of β-Carotene from Bread

Quarters from one slice of bread with micronised fat particles and from one slice of bread with large fat particles gave the following absorbances at 450 nm and, being 537 the molecular weight of β-carotene, the following amounts of β-carotene/bread quarter. Average values and standard deviations are also given.

| | Large fat particles bread | | Micronised fat particles bread | |
|---|---|---|---|---|
| | | amount in 7.5 g | | amount in 7.5 g |
| bread | abs | of bread | abs | of bread |
| quarter 1 | 0.275 | 0.2148 g | 0.516 | 0.4038 g |
| quarter 2 | 0.244 | 0.1890 g | 0.617 | 0.4833 g |
| quarter 3 | 0.435 | 0.3405 g | 0.530 | 0.4146 g |
| quarter 4 | 0.508 | 0.3974 g | 0.630 | 0.4919 g |
| average | 0.366 | 0.2854 g | 0.5733 | 0.4484 g |
| standard dev | | 0.099762 | | 0.045614 |

7.3. Conclusions

Images of the bread showed that bread with micronised fat particles was more homogeneous than bread with large fat particles. β-Carotene analysis of the bread slices also showed, on the basis of the higher standard deviation of the quarters of bread with large fat particles compared to the quarters of bread with micronised fat particles, that micronised fat particles allow obtaining more homogeneous food products.

The higher average amount of β-carotene extracted from the read with micronised fat particles can be explained considering that in the bread made with large fat particles, large fat particles were primarily located in/near the crust.

### Experiment 8

Improved dosing of micronised fat particles compared to unsieved fat particles.

Reproducible dosing of ingredients is important to maintain the same quality of food products, thus avoiding variations from batch to batch.

8.1. Material and Methods

Production of Raspberry Micronised Fat Particles and of Unsieved Raspberry Fat Particles

The following ingredients were used in this experiment:

| Ingredient | Percentage |
|---|---|
| CLSP 870 (partially hydrogenated | 31.5% |
| vegetable oil - soybean, cottonseed) | |
| Icing sugar | 30.13% |
| Granulated sugar | 16.0% |
| 28DE maltodextrin | 17.0% |
| Malic acid | 1.0% |
| Tricalcium phosphate | 0.4% |
| DD-40 Raspberry powder | 1.56% |
| FD&C red # 40 09310 (food colorant) | 2.0% |
| FD&C Blue #2 09901 (food colorant) | 0.1% |
| Lecithin, liquid | 0.01% |

Raspberry micronised fat particles were produced following laboratory flake make-up procedure, as reported in the patent (Method 1.1). A 187G screen size Comil was used at 1200 rpm for grinding.

Medium Raspberry micronised fat particles were sieved and the fraction between US #12 and #6 (Swenco sieves) obtained.

Unsieved Raspberry fat particles were obtained following the same procedure used to produce micronised fat particles except that they were not sieved after grinding.

Easiness of Dosing Experiment

To prove the easiness of dosing, 20 subsequent volumes of micronised fat particles or unsieved fat particles were scooped from a reservoir of product, simulating a dose dispenser.

Each dose was weighted and the standard deviation measured for both the Raspberry micronised fat particles samples and the unsieved Raspberry fat particles.

8.2. Results

Production of Raspberry Micronised Fat Particles

The percentage of sieved (retained between sieves #6 and #12) Raspberry micronised-fat particles and of unsieved Raspberry fat particles within ±0.4*MWD was 88.7% and 66.8% respectively. The percentage was calculated as reported in the patent (Method 1.1).

The MWD of the micronised fat particles was 2289.4 and that of the unsieved fat particles was 2361.7.

The particle size distribution of the Raspberry micronised fat particles retained between sieve #6 and #12 and of the unsieved Raspberry fat particles is shown in the following table and graph.

| | Micronised fat particles | | | | Unsieved fat particles | | | |
|---|---|---|---|---|---|---|---|---|
| | Screen | Mean | | | Screen | Mean | | |
| US# | size | Size | g | % | size | Size | g | % |
| 4 | | | | | 4750 | 4750 | 0.3 | 0.1 |
| 6 | 3350 | 3350 | 0.8 | 0.5 | 3350 | 4050 | 32.05 | 13.1 |
| 8 | 2360 | 2855 | 61.2 | 41.4 | 2360 | 2855 | 96.22 | 39.4 |
| 10 | 2000 | 2180 | 37.8 | 25.5 | 2000 | 2180 | 39.95 | 16.4 |
| 12 | 1700 | 1850 | 21.4 | 14.5 | 1700 | 1850 | 18.20 | 7.4 |
| 14 | 1400 | 1550 | 19.2 | 13.0 | 1400 | 1550 | 13.87 | 5.7 |
| 16 | 1180 | 1290 | 5.2 | 3.5 | 1180 | 1290 | 9.72 | 4.0 |
| 18 | | | | | 1000 | 1090 | 6.13 | 2.5 |
| 20 | | | | | 850 | 925 | 3.87 | 1.6 |
| Pan | 1000 | 1000 | 2.4 | 1.6 | 250 | 250 | 24.00 | 9.8 |
| Tot | | | 148 | 100% | | | 244.31 | 100% |

[image]

Easiness of Dosing Experiment

The amount of sample scooped from the Raspberry unsieved fat particles and the Raspberry micronised fat particles” reservoirs are shown in the following table. The table also shows the average amount scooped and the standard deviation of scooping.

| | Unsieved fat | Micronised fat |
|---|---|---|
| Scoop no. | particles | particles |
| 1 | 372.4 | 354.6 |
| 2 | 369.3 | 351.6 |
| 3 | 383.5 | 354.1 |
| 4 | 373.2 | 357.3 |
| 5 | 378.5 | 359.6 |
| 6 | 375.2 | 353.4 |
| 7 | 376.1 | 355.1 |
| 8 | 374.8 | 355.9 |
| 9 | 396.7 | 355.1 |
| 10 | 379.2 | 355.1 |
| 11 | 373.3 | 352.3 |
| 12 | 386.5 | 354.7 |
| 13 | 380.3 | 357.1 |
| 14 | 382.8 | 357.8 |
| 15 | 379.0 | 356.4 |
| 16 | 380.2 | 359.2 |
| 17 | 380.3 | 354.3 |
| 18 | 381.2 | 350.4 |
| 19 | 399.3 | 355.4 |
| 20 | 373.5 | 355.9 |
| Average | 379.77 | 355.27 |
| Standard | 7.571 | 2.326 |
| Deviation | | |

8.3. Conclusions

The Raspberry micronised fat particles produced were within the patent specification for what concerns the MWD and the particle size distribution.

Compared to the unsieved Raspberry fat particles, Raspberry micronised fat particles showed improved easiness of dosing since dosing was more reproducible, as standard deviation results showed.

### Experiment 9

Improved stability of fish oil micronised fat particles compared to unsieved fish oil fat particles.

9.1. Material and Methods

Production of Fish Oil Micronised Fat Particles and Unsieved Fish Oil Fat Particles

The following ingredients were used in this experiment:

| Ingredient | Percentage |
|---|---|
| maltodextrine | 28.12% |
| pastry flour | 35.3% |
| giuvaudan Roure Natural Lemon Flavour 201 | 1.65% |
| fat blend | 34.8% |
| yellow #5 | 0.03% |
| lecithin | 0.1% |
| Fat blend | |
| 17 stearine (partially hydrogenated soybean | 15% |
| oil) | |
| CLSP 870 (partially hydrohgenated vegetable | 55% |
| oil - soybean, cottonseed) | |
| EPA/DHA enriched fish oil | 30% |

Fish oil micronised fat particles were produced following laboratory flake make-up procedure, as reported in the patent (Method 1.1). A 312G screen size Comil was used at 1200 rpm. Large fish oil micronised fat particles were sieved and the fraction between US #3 and #8 (RoTap sieves) obtained.

Unsieved fish oil fat particles were obtained following the same procedure used to produce fish oil micronised fat particles except that they were not sieved after milling.

Storage Trial

Samples of unsieved fish oil particles and of fish oil micromised fat particles were stored in sandwich boxes at 25° C. for 25 days. The lid of each box had four punched holes for the free circulation of air.

Panelling

Paneling was carried out in Loders Croklaan USA. 12 panelists were used for the sensory evaluation. Using the unsieved fish oil fat particles as reference, panelists were asked to score the intensity of fish off-flavours of fish oil micronised fat particles using the following scale:

+/−3.0=big difference

+/−2.5=very clear difference

+/−2.0=clear difference

+/−1.5=very noticeable difference

+/−1.0=noticeable difference

+/−0.5=slight difference

0=same as reference

+ and − referred to less and more respectively.

9.2. Results

Production of Fish Oil Micronised Fat Particles and Fish Oil Unsieved Fat Particles

The percentage of sieved (retained between sieves #3 and #8) fish oil micronised fat particles and unsieved fish oil fat particles within +0.4*MWD were 95.0% and 70.5% respectively. The percentage was calculated as reported in the patent (Method 1.1).

The MWD of the fish oil micronised fat particles and of the unsieved fat particles were 3808.0 and 3737.1, respectively.

The particle size distribution of the fish oil micronised fat particles retained between sieve #3 and #8 and of the unsieved fish oil fat particles are shown in the following table.

| | Micronised fat particles | | | | Unsieved fat particles | | | |
|---|---|---|---|---|---|---|---|---|
| | Screen | Mean | | | Screen | Mean | | |
| US# | size | Size | Grams | % | size | Size | Grams | % |
| 0.25″ | 6300 | 6300 | 0 | 0 | | | | |
| 3.5 | 5600 | 5950 | 0 | 0 | 5600 | 5600 | 9.23 | 9.2 |
| 4 | 4750 | 5175 | 12.79 | 12.7 | 4750 | 5175 | 14.66 | 14.6 |
| 6 | 3350 | 4050 | 56.00 | 55.7 | 3350 | 4050 | 41.94 | 41.9 |
| 8 | 2360 | 2855 | 30.45 | 30.3 | 2360 | 2855 | 19.13 | 19.1 |
| 10 | 2000 | 2180 | 1.18 | 1.2 | 2000 | 2180 | 3.74 | 3.7 |
| 12 | | | | | 1700 | 1850 | 2.57 | 2.6 |
| 14 | | | | | 1400 | 1550 | 1.94 | 1.9 |
| 16 | | | | | 1180 | 1290 | 1.35 | 1.3 |
| 18 | | | | | 1000 | 1090 | 1.39 | 1.4 |
| 20 | | | | | 850 | 925 | 1.20 | 1.2 |
| Pan | 1700 | 1850 | 0.05 | 0 | 500 | 675 | 3.02 | 3.0 |
| | | | 100.47 | 100 | | | 100.17 | 100 |

The particle size distribution is also shown in the following graph.

[image]

Panelling

Fish oil micronised fat particles and fish oil unsieved fat particles did not have any fish flavour at time zero, i.e. immediately after production. In the following table results of the sensory evaluation, after 25 days storage, of the fish oil micronised fat particles are shown. The unsieved fraction was used as reference and consequently represents the “zero” on the line scale.

| Attribute | | Average | Ratio +ve or −ve |
|---|---|---|---|
| Intensity off- | less | −1.7 | 12/12 = less fish |
| fish flavour | | | aroma |

9.3. Conclusions

The intensity of fishy flavour has been previously used to establish shelf-life/stability of food products/ingredients enriched with omega-3 fatty acids, primarily of fish origin (International Journal of Food Sciences and Nutrition, 50, 39-49, 1999). Fishy off-flavours are caused by the oxidation of omega-3 fatty acids, very unstable in the presence of oxygen and light.

In this trial, the comparison between stored fish oil micronised fat particles and stored unsieved fish oil fat particles showed that the fishy off-flavour micronised fat particles was less intense. Therefore it can be concluded that fish oil “micronised fat particles” are more stable towards oxidation than unsieved fish oil fat particles during storage.

### Experiment 10

Improved oral melt and/or hardness and/or texture of micronised fat particles compared to unsieved fat particles.

10.1. Material and Methods

Production of Strawberry Micronised Fat Particles and Unsieved Strawberry Fat Particles

The following ingredients were used in this experiment:

| Ingredient | Percentage |
|---|---|
| Aratex II (partially hydrogenated vegetable oil - | 31.0% |
| soybean cottonseed) | |
| Icing sugar 6X | 30.13% |
| Sanding sugar | 16.05% |
| Unbleached pastry flour | 17.0% |
| Malic acid | 1.5% |
| Tricalcium phosphate | 0.4% |
| Sodium citrate, dehydrate | 0.3% |
| Strawberry flavour | 1.5% |
| DD-40 strawberry powder | 2.0% |
| FD&C Red #40 09310 (food colorant) | 0.1% |
| FD&C Blue #2 09901 (food colorant) | 0.01% |
| Lecithin powder | 0.01% |

Micronised fat particles were produced following laboratory flake make-up procedure, as reported in the patent (Method 1.1). A 187G screen size Comil was used at 1200 rpm.

Medium Strawberry micronised fat particles were sieved and the fraction between US #6 and #12 (Swenco sieves) obtained.

Unsieved Strawberry fat particles were obtained following the same procedure used to produce Strawberry micronised fat particles except that they were not sieved after milling.

Preparation of Strawberry Flavoured Margarine

Samples of unsieved Strawberry fat particles or Strawberry micromised fat particles” were combined to commercial margarine in the amount of 10% and mixed with a Hobart mixer for 5 minutes at low speed. Samples were then stored in sandwich boxes in the fridge and paneled after 25 days storage.

Panelling

Paneling was carried out in Loders Croklaan USA. 12 panelists were used for the sensory evaluation. Using the margarine containing unsieved Strawberry fat particles as reference, panelists were asked to compare it against the margarine made with Strawberry micronised fat particles. The sensory score sheet included a line scale for each attribute. The scale range went from +3 and −3, and characterized by the following levels:

+/−3.0=big difference

+/−2.5=very clear difference

+/−2.0=clear difference

+/−1.5=very noticeable difference

+/−1.0=noticeable difference

+/−0.5=slight difference

0=same as reference

+ and − referred to less and more respectively.

The following attributes were evaluated in margarine:

| | negative | 0 | positive |
|---|---|---|---|
| Bleeding of the inclusions | less | 0 | more |
| Appearance of particles | fewer | 0 | more |
| Flavour impact | less | 0 | more |
| Meltdown | slower | 0 | quicker |
| Waxiness | less | 0 | more |

Legend: Bleeding of the inclusions=release of colour from the particles into the margarine; Appearance of particles=clear distinction between the margarine background and the reddish particle; Flavour impact=localised boost of flavour/flavour intensity; Meltdown=speed at which the product melts in the mouth; Waxiness=resembling wax in texture/mouth feel.

10.2. Results

Production of Strawberry Micronised Fat Particles and Strawberry Unsieved Fat Particles

The percentage of sieved (retained between sieves #6 and #12) Strawberry micronised fat particles and unsieved Strawberry fat particles within ±0.4*MWD was 89.5% and 47.4%, respectively. The percentage was calculated as reported in the patent (Method 1.1).

The MWD of the Strawberry micronised fat particles and unsieved Strawberry fat particles were 2948.0 and 2241.5 respectively.

The particle size distribution of the Strawberry “micronised fat particles” retained between sieve #6 and #12 and of the unsieved Strawberry fat particles were the following.

| | Micronised fat | | | | Unsieved fat | | | |
|---|---|---|---|---|---|---|---|---|
| | particles | | | | particles | | | |
| | Screen | Mean | | | Screen | Mean | | |
| US# | size | Size | Grams | % | size | Size | Grams | % |
| 4 | 4750 | 4750 | 0.00 | 0% | 4750 | 4750 | 0.10 | 0.13% |
| 6 | 3350 | 4050 | 19.61 | 19.66% | 3350 | 4050 | 12.70 | 16.70% |
| 8 | 2360 | 2855 | 62.02 | 62.19% | 2360 | 2855 | 27.62 | 36.32% |
| 10 | 2000 | 2180 | 13.28 | 13.32% | 2000 | 2180 | 8.04 | 10.57% |
| 12 | 1700 | 1850 | 4.00 | 4.01% | 1700 | 1850 | 3.37 | 4.43% |
| 14 | 1400 | 1550 | 0.54 | 0.54% | 1400 | 1550 | 2.44 | 3.21% |
| 16 | | | | | 1180 | 1290 | 1.84 | 2.42% |
| 18 | | | | | 1000 | 1090 | 3.44 | 4.52% |
| 20 | | | | | 850 | 925 | 2.83 | 3.72% |
| pan | 1180 | 1180 | 0.28 | 0.28% | 250 | 250 | 13.67 | 17.98% |
| | | | 99.73 | 100% | | | 76.05 | 100% |

The particle size distribution is also shown in the following graph.

[image]

Panelling

In the following table results of the sensory evaluation, after 25 days storage, of margarine with Strawberry micronised fat particles are shown. The margarine with unsieved Strawberry fat particles was used as reference and consequently represented the “zero” on the line scale.

| | | | Ratio pos | Ratio specific |
|---|---|---|---|---|
| Attribute | | Average | or neg | difference |
| Bleeding of | less | −0.9 | 9/12 = less | 9/12 = −1.0 |
| inclusions | | | bleeding of | noticeable |
| | | | inclusions | difference |
| Appearance of | more | +0.4 | 8/12 = more | 7/12 = +1.0 |
| particles | | | particles | noticeable |
| | | | | difference |
| Flavour | more | +0.3 | 7/12 = more | 7/12 = +1.0 |
| impact | | | flavour impact | noticeable |
| | | | | difference |
| Meltdown | slower | −0.1 | 7/12 = slower | 4/12 = −1.0 |
| | | | meltdown | noticeable |
| | | | | difference |
| Waxiness | more | −0.2 | 7/12 = more | 7/12 = +1.0 |
| | | | waxy | noticeable |
| | | | | difference |

10.3. Conclusions

From the results of the paneling the following conclusions could be drawn:

In the margarine with Strawberry micronised fat particles, inclusions were more distinctive than in the control (margarine with unsieved Strawberry fat particles), since there was less bleeding and more particle appearance (clear distinction between the margarine background and the reddish particles).

In the margarine with Strawberry micronised fat particles there was a higher mouth sensation of the inclusions than in the control. Inclusions appeared to be waxier and had a slower meltdown. Therefore they were texturally more identifiable as distinctive inclusions.

Finally it appeared that there was clearer flavour identification from both the margarine and the inclusion when Strawberry micronised fat particles were used in the production of the flavoured margarine. The latter showed, namely, a more intense flavour from the inclusion than the control.

Overall it could be concluded that using Strawberry micronised fat particles in the production of flavoured margarine, there was improvement in both visual and mouth perceptions, if compared to margarine produced with Strawberry unsieved fat particles.

### Experiment 11

Shakable Sauce with Micronised Fat Particles

11.1. Material and Methods

Production of Tomato/Basil Micronised Fat Particles

The following ingredients were used in this experiment:

| Ingredient | Percentage |
|---|---|
| Aratex L (partially hydrogenated vegetable oil - | 35% |
| soybean and cotton seed) | |
| Unbleached pastry flower | 36.25% |
| Tomato powder | 24% |
| Granulated salt | 1.5% |
| Citric acid anhydrous, granular | 0.5% |
| Tomato flavour (in powder) | 0.2% |
| Tomato flavour (in oil form) | 2% |
| Basil flavour (in oil form) | 0.5% |
| Basil powder | 0.05% |

Micronised fat particles were produced following laboratory flake make-up procedure, as reported in the patent (Method 1.1). A 187G screen size Comil was used at 1200 rpm for grinding.

Medium tomato/basil micronised fat particles were sieved and the fraction between US #4 and #8 (RoTap sieves) obtained.

Shakeable Sauce Application

150 g of “pipe rigate” pasta was cooked in 1 liter salted boiling water for 9 min. Pasta was then drained and poured into a bowl. 30 g Of tomato/basil micronised fat particles were then mixed with the pasta for 30 s and served.

11.2. Results

Production of Tomato/Basil Micronised Fat Particles

The percentage of sieved (retained between sieves #8 and #4) micronised fat particles within ±0.4*MWD was 93.2%. The percentage was calculated as reported in the patent (Method 1.1).

The particle size distribution of the “micronised fat particales” retained between sieve #8 and #4 was the following.

| | Screen | Mean | | |
|---|---|---|---|---|
| US# | size | Size | Grams | % |
| 4 | 4750 | 4750 | 0 | 0 |
| 6 | 3350 | 4050 | 28.67 | 25.4 |
| 8 | 2360 | 2855 | 79.41 | 70.4 |
| 10 | 2000 | 2180 | 4.57 | 4.05 |
| 12 | 1700 | 1850 | 0.08 | 0.07 |
| Pan | 1400 | 1550 | 0.09 | 0.08 |
| Total | | | 112.82 | 100.00% |

[image]

The MWD of the micronised fat particles was 3129.6.

Shakeable Sauce Application

Pasta sauce looked creamy and homogeneous after stirring, with a rich tomato and basil flavour, resembling the colour and flavour of a freshly made tomato puree.

11.3. Conclusions

The micronised fat particles could be used in a shakable sauce application to give additional/different texture and/or flavour and/or appearance to a variety of food such as meat and vegetable dishes, pasta, desserts. Furthermore they could be used in the food service sector to diversify products starting from a common base (i.e. pasta, crepes, hotdogs, ice-creams, yogurt, frappe'), either in the form of topping or inclusion.

### Experiment 12

Shakable Topping/Inclusion with Micronised Fat Particles

12.1. Material and Methods

Production of Cinnamon/Streusel Micronised Fat Particles

The following ingredients were used in this experiment:

| Ingredient | Percentage |
|---|---|
| Aratex L (partially hydrogenated vegetable oil - | 28.91% |
| soybean and cottonseed) | |
| Powdered sugar | 35.01% |
| Granulated sugar | 23.05% |
| Cinnamon powder | 11.00% |
| Cinnamon flavour Hasegawa | 2.00% |
| Lecithin powder | 0.03% |

Micronised fat particles were produced following laboratory flake make-up procedure, as reported in the patent (Method 1.1). A 187G screen size Comil was used at 1200 rpm for grinding.

Medium cinnamon micronised fat particles were sieved and the fraction between US #6 and #12 (RoTap sieves) obtained.

Shakeable Topping/Inclusion Application

A dessert mix (“Milky bar”) was prepared following the recipe indicated on the packaging. 300 ml of cold milk were poured into a large bowl. 80 g of dessert mix was added and whisked until creamy.

a) Inclusion application: half was added of 15 g of cinnamon micronised fat particles, mixed with a spoon and spooned on a cup. The cup was left in the fridge for 20 min before serving.

b) Topping application: the other half of the cream was spooned on a cup and stored in the fridge for 20 min. Before serving the cream was sprinkled with 8 g of cinnamon micronised fat particles.

12.2. Results

Production of Cinnamon Micronised Fat Particles

The percentage of sieved (retained between sieves #6 and #12) micronised fat particles within +0.4*MWD was 89.9%.

The range of MWD−0.4*MWD to MWD+0.4*MWD was calculated. The percentage calculated is based on the fact that a plot of the cumulative distribution vs the particle size is a straight line.

The particle size distribution of the micronised fat particles retained between sieve #8 and #20 was the following.

| | Screen | Mean | | |
|---|---|---|---|---|
| US# | size | Size | Grams | % |
| 0.25″ | 6300 | 6300 | 0 | 0.0% |
| 3.5 | 5600 | 5950 | 0 | 0.0% |
| 4 | 4750 | 5175 | 0 | 0.0% |
| 6 | 3350 | 4050 | 0.45 | 0.4% |
| 8 | 2360 | 2855 | 47.43 | 47.3% |
| 10 | 2000 | 2180 | 23.40 | 23.3% |
| 12 | 1700 | 1850 | 12.69 | 12.6% |
| 14 | 1400 | 1550 | 10.25 | 10.2% |
| 16 | 1180 | 1290 | 4.73 | 4.7% |
| 18 | 1000 | 1090 | 1.43 | 1.4% |
| 20 | 850 | 925 | 0 | 0.0% |
| 30 | 600 | 725 | 0 | 0.0% |
| 40 | 425 | 512.5 | 0 | 0.0% |
| 50 | 300 | 362.5 | 0 | 0.0% |
| Pan | 250 | 275 | 0 | 0.0% |
| Total | | | 100.38 | 100.00% |

[image]

The MWD of the micronised fat particles was 2344.

Shakeable Topping/Inclusion Application

Both samples had a distinct cinnamon flavour. In the sample in which cinnamon micronised fat particles were used as inclusions, particles did not break during mixing. In both samples there was a clear distinction between the particles and the background, particularly in appearance but also in flavour, with a strong burst of cinnamon flavour as soon as particles were crunched in the mouth.

12.3. Conclusions

The micronised fat particles could be used in a shakeable topping/inclusion to give additional/different texture and/or flavour and/or appearance to a variety of food such as meat and vegetable dishes, pasta, desserts. Furthermore they could be used in the food service sector to diversify products starting from a common base (i.e. pasta, crepes, hotdogs, ice-creams, yogurt, frappe'), either in the form of topping or inclusion.

### Experiment 13

Microwave Application of Micronised Fat Particles

13.1. Material and Methods

Production of β-Carotene Micronised Fat Particles

The following ingredients were used in this experiment:

| Ingredient | Percentage |
|---|---|
| Aratex L (partially hydrogenated vegetable oil - | 36.00% |
| soybean and cotton seed) | |
| Unbleached pastry flower | 34.50% |
| Maltodextrin | 24.40% |
| NaCl | 1.97% |
| Citric acid, granulate | 0.49% |
| β-carotene, 30% in oil (Roche) | 2.64% |

Micronised fat particles were produced following laboratory flake make-up procedure, as reported in the patent (Method 1.1). A 156G screen size Comil was used at 1800 rpm for grinding.

Small β-carotene micronised fat particles were sieved and the fraction between US #16 and #8 (RoTap sieves) obtained.

Microwave Application

3 g of β-carotene micronised fat particles” were placed on a slice of Wasa biscuit/bread and microwaved for 1 min at 600 W.

13.2. Results

Production of β-Carotene Micronised Fat Particles

The percentage of sieved (retained between sieves #8 and #16) micronised fat particles within ±0.4*MWD was 98.2%.

The range of MWD-0.4*MWD to MWD+0.4*MWD was calculated. The percentage calculated is based on the fact that a plot of the cumulative distribution vs the particle size is a straight line.

The particle size distribution of the micronised fat particles retained between sieve #8 and #16 was the following.

| | Screen | Mean | | |
|---|---|---|---|---|
| US# | size | Size | Grams | % |
| 8 | 2360 | 2855 | 0.17 | 0.17% |
| 10 | 2000 | 2180 | 25.57 | 25.61% |
| 12 | 1700 | 1850 | 30.76 | 30.81% |
| 14 | 1400 | 1550 | 26.22 | 26.26% |
| 16 | 1180 | 1290 | 12.73 | 12.75% |
| 18 | 1000 | 1090 | 3.8 | 3.81% |
| 20 | 850 | 925 | 0.13 | 0.13% |
| Pan | 500 | 675 | 0.46 | 0.46% |
| Total | | | 99.84 | 100.00% |

[image]

The MWD of the micronised fat particles was 1750.5.

Microwave Application

When the slice of bread/biscuits was taken out of the microwave, the particles were melted but in appearance still retained most of the structure. This allowed the particles to have a crispy look without falling down from the slice, as the following picture shows.

13.3. Conclusions

The micronised fat particles could be used in a “microwave” application to give additional/different texture and/or flavour and/or appearance to quick “warmup&go” fast snacks. Furthermore they could be used in the food service sector to diversify products starting from a unique base (i.e. muffin, waffles).

Appendix

### Experiment 1

TABLE 1.10
Particle size distribution of ground,
unsieved material from experiment 1

| Average Diameter | Percentage | Weight Diameter |
|---|---|---|
| (microns) | (%) | (microns) |
| 4050 | 3.2 | 129.6 |
| 2855 | 25.7 | 733.7 |
| 2180 | 8.1 | 176.6 |
| 1850 | 11.7 | 216.5 |
| 1550 | 7.8 | 120.9 |
| 1290 | 6.4 | 82.6 |
| 1090 | 7.3 | 79.6 |
| 925 | 2.0 | 18.5 |
| 675 | 27.2 | 183.6 |

TABLE 1.11
Particle size distribution of fraction A from experiment 1

| Average Diameter | Percentage | Weight Diameter |
|---|---|---|
| (microns) | (%) | (microns) |
| 4050 | 3.1 | 125.6 |
| 2855 | 74.7 | 2132.7 |
| 2180 | 18.4 | 401.1 |
| 1850 | 3.3 | 61.1 |
| 1550 | 0.2 | 3.1 |

TABLE 1.12
Particle size distribution of fraction B from experiment 1

| Average Diameter | Percentage | Weight Diameter |
|---|---|---|
| (microns) | (%) | (microns) |
| 2855 | 0 | — |
| 2180 | 13.3 | 289.9 |
| 1850 | 33.1 | 612.4 |
| 1550 | 22.7 | 351.9 |
| 1290 | 16 | 206.4 |
| 1090 | 11 | 119.9 |
| 925 | 2.3 | 21.3 |
| 675 | 1.6 | 10.8 |

TABLE 1.13
Particle size distribution of fraction C from experiment 1

| Average Diameter | Percentage | Weight Diameter |
|---|---|---|
| (microns) | (%) | (microns) |
| 1290 | 0.2 | 2.6 |
| 1090 | 4.2 | 45.8 |
| 925 | 5.4 | 50.0 |
| 725 | 24.9 | 180.5 |
| 512.5 | 23.1 | 118.4 |
| 362.5 | 37.9 | 137.4 |
| 275 | 4.3 | 11.8 |

TABLE 1.14
Mean weight diameter of each fraction from experiment 1

| | Mean weight | | |
|---|---|---|---|
| | diameter | % within ± | % within ± |
| Fraction | (microns) | 0.4 of MWD | 0.3 of MWD |
| Unsieved fraction | 1741.6 | 41.5 | 30.7 |
| Fraction A | 2723.6 | 97.5 | 94.6 |
| Fraction B | 1612.6 | 92.8 | 78.5 |
| Fraction C | 546.5 | | |

### Experiment 2

TABLE 1.15
Particle size distribution of ground,
unsieved material from experiment 2

| Average Diameter | Percentage | Weight Diameter |
|---|---|---|
| (microns) | (%) | (microns) |
| 4050 | 0.8 | 32.4 |
| 2855 | 15.4 | 439.7 |
| 2180 | 14.6 | 318.3 |
| 1850 | 11.9 | 220.2 |
| 1550 | 11.7 | 181.4 |
| 1290 | 10.1 | 130.3 |
| 1090 | 9.5 | 103.6 |
| 925 | 3.3 | 30.5 |
| 675 | 22.5 | 151.9 |

TABLE 1.16
Particle size distribution of fraction A from experiment 2

| Average Diameter | Percentage | Weight Diameter |
|---|---|---|
| (microns) | (%) | (microns) |
| 4050 | 7.2 | 291.6 |
| 2855 | 70 | 1998.5 |
| 2180 | 21.3 | 464.3 |
| 1850 | 1 | 18.5 |
| 1550 | 0.2 | 3.1 |

TABLE 1.17
Particle size distribution of fraction B from experiment 2

| Average Diameter | Percentage | Weight Diameter |
|---|---|---|
| (microns) | (%) | (microns) |
| 2855 | 0 | — |
| 2180 | 21.5 | 468.7 |
| 1850 | 28.7 | 531 |
| 1550 | 23.3 | 361.2 |
| 1290 | 25.9 | 334.1 |
| 1090 | 0 | — |
| 925 | 0.4 | 3.7 |
| 675 | 0.3 | 2 |

TABLE 1.18
Mean weight diameter of each fraction from experiment 2

| | Mean weight | | |
|---|---|---|---|
| | diameter | % within ± | % within ± |
| Fraction | (microns) | 0.4 of MWD | 0.3 of MWD |
| Unsieved fraction | 1608.3 | 54.2 | 40.2 |
| Fraction A | 2776 | 95.1 | 92.8 |
| Fraction B | 1700.7 | 99.6 | 89.3 |

1: Micronised fat continuous particles comprising fat and non fat ingredients, wherein the particles have a mean weight diameter (MWD) of 700 to 4000 microns, while the particles have a particle size distribution so that more than 75 wt % of the particles have a particle size that is inside the range (MWD+0.4×MWD) to (MWD−0.4×MWD).

2: Micronised fat continuous particles according to claim 1 wherein the particles have a MWD of 1000 to 3500 microns, preferably 1500 to 3000 microns.

3: Micronised particles according to claims 1 or 2 wherein the particles have a size distribution so that more than 75 wt % is inside the range (MDW+0.3×MDW) to (MDW−0.3×MDW).

4: Micronised particles according to claim 1 wherein the particles comprise 10 to 90 wt % of non fat ingredients, preferably 20 to 80 wt %, more preferably 25 to 60 wt %.

5: Micronised particles according to claim 1 wherein the non fat ingredients are at least one ingredient selected from the group consisting of sugars, carbohydrates, starches, modified starches and flavouring compounds.

6: Micronised particles according to claim 1 wherein the non fat ingredients are nutritionally active ingredients.

7: Micronised particles according to claim 1 wherein the fat is a fat that displays a melting point between −5° C. and 75° C., preferably between 10 and 50° C., most preferably between 15 and 45° C.

8: Micronised particles according claim 7 wherein the fat is selected from a fat selected from the group consisting of: sunflower oil, palm oil, rape oil, cotton seed oil, soy bean oil, maize oil, shea oil, cocoa butter, or fractions thereof or in a hardened form or as fraction of the hardened oil or as partially hydrolysed oil rich in diglycerides or as mixtures thereof.

9: Micronised particles according to claim 7 wherein the fat is a nutritionally active fat, preferably selected from a CLA-glyceride or a fat that comprises PUFA fatty acid in high amounts such as fish oil, fish oil concentrates, fungal oils.

10: Micronised particles according to claim 1 wherein the flavour is selected from the group consisting of butter flavour, cinnamon flavour, fruit flavour, cheese flavour.

11: Micronised particles according to claim 1 wherein the particles comprise less than 2 wt % of water.

12: Food products comprising a fat phase wherein more than 30 wt % of the micronised particles according to claim 1 are present.

13: Food products according to claim 12 wherein the food product is selected from the group consisting of ice cream, baked goods, coatings, fillings, toppings, soups, sauces, dry mixes, spreads.

14: Process for the preparation of micronised fat continuous particles with the composition according to claim 1 wherein:
a fat melt is made
non fat ingredients are slurried in the molten fat
the slurry is cooled, preferably on a flaking drum cooler
flakes of a fat continuous slurry are collected from the drum flaker
which flakes optionally are reduced in size, preferably by a breaker bar system
whereupon either the flakes or the size reduced flakes are subjected to a cryomilling by cooling them with a cryocoolant, such as liquid nitrogen or solid carbon dioxide and reducing them in size while cold, in particular while having a temperature of −20 to 10° C.

15: Process according to claim 14 wherein the particles are milled in the cryomiller to a particle size of more than 20 microns and in particular to particles with the size and size distribution, mentioned in claim 1.

16: Method which comprises adding particles with the composition according to claim 1 to food products to:
improve the bioavailability of the nutritional ingredients present in the particles and/or
to improve the stability of the nutritional ingredients present in the food products and/or
to improve oral melt, hardness or texture of food products and/or
to improve the homogeneity of the active ingredient in the food products and/or
to improve the ease of dosing of minor components in food products.
